(19) United States
(12) Patent Application Publication
(10) Pub. No.: US 2011/0301023 A1
(43) Pub. Date: Dec. 8, 2011

(54) HIGH TEMPERATURE STABLE ANATASE TITANIUM DIOXIDE

(75) Inventor: Carmine Torardi, Wilimington, DE (US)

(73) Assignee: E.I.Dupont de Nemours and Company, Wilimington, DE (US)

(21) Appl. No.: 13/202,479

(22) PCT Filed: Mar. 17, 2010
(86) PCT No.: PCT/US10/27590

§ 371 Date: Aug. 19, 2011

Related U.S. Application Data
(60) Provisional application No. 61/161,135, filed on Mar. 18, 2009.

(51) Int. Cl. B01J 21/06

(52) U.S. Cl. 502/242; 502/439

(57) ABSTRACT

The disclosure relates to a process for making anatase titanium dioxide which is stable at temperatures above 900° C., comprising:
(a) mixing an organic water-miscible solvent and a titanate to form a solution comprising titanium;
(b) hydrolyzing the solution comprising titanium in the presence of a source of silicon and a source of aluminum to form a hydrolyzed composition of titanium doped with silicon and aluminum;
(c) separating the hydrolyzed composition of titanium doped with silicon and aluminum; and
(d) calcining the hydrolyzed composition of titanium doped with silicon and aluminum to form high temperature stable anatase titanium dioxide doped with silicon and aluminum and high temperature stable anatase titanium dioxide made by the foregoing process.

### CROSS REFERENCE TO RELATED APPLICATIONS

This application claims the benefit of U.S. Provisional Application No. 61/161,135, filed Mar. 18, 2009 which is incorporated by reference in its entirety.

This application is related to PCT/US08/82307 filed on Nov. 4, 2008 which claims the benefit of U.S. Provisional Application No. 61/001,841 filed Nov. 5, 2007 (DuPont Docket No. TT0051) which is related to Ser. No. 11/393,293 which is a continuation-in-part of application Ser. No. 11/172,099, filed on Jun. 30, 2005 which is a continuation in part of application Ser. No. 10/995,968, filed on Nov. 23, 2004 (DuPont Docket No. CL2311USNA) which are incorporated hereinby reference in their entireties.

This application is also related to PCT/US07/26104 filed on Dec. 20, 2007 which claims the benefit of Provisional Application No. 60/876,382 filed on Dec. 21, 2006 (DuPont Docket No. TT0056), incorporated herein by reference in their entireties.

### FIELD OF THE INVENTION

This disclosure relates to anatase titanium dioxide and processes for making anatase titanium dioxide, which is stable at temperatures above 900° C.

### BACKGROUND

The anatase crystalline form of titanium dioxide is known for use in catalyst applications. For example, anatase titanium dioxide is known for use in catalyzing the following reactions either as the catalyst itself or as a catalyst support: alkylation of phenol, photo-oxidation of organics, and when combined with vanadium oxide, reduction of NOx from automobile exhaust to nitrogen and water.

High temperature applications for anatase titanium dioxide are limited because anatase is known to convert to rutile at temperatures at about 650° C. It is known that doping the titanium dioxide precursor with silicon can increase the anatase-to-rutile transition temperature. It has been found that stability can be increased to about 900° C., but this does not solve the problem of anatase stability at temperatures exceeding 900 ° C. which can be very common in catalytic applications.

### SUMMARY OF THE INVENTION

The disclosure relates to a process for making anatase titanium dioxide which is stable at temperatures above 900° C., in particular at temperatures ranging from above 900° C. to about 1200 ° C., comprising:

(a) mixing an organic water-miscible solvent and a titanate to form a solution comprising titanium;

(b) hydrolyzing the solution comprising titanium in the presence of a source of silicon and a source of aluminum to form a hydrolyzed composition of titanium doped with silicon and aluminum;

(c) separating the hydrolyzed composition of titanium doped with silicon and aluminum; and

(d) calcining the hydrolyzed composition of titanium doped with silicon and aluminum to form high temperature stable anatase titanium dioxide doped with silicon and aluminum, in particular the calcining temperatures can range from about 400° C. to about 1200° C.

The source of silicon can be added to the solution comprising titanium, the source of aluminum can be added to the solution comprising titanium or both can be added to the solution comprising titanium. Mixing with water forms the hydrolyzed composition.

The solution comprising titanium can be hydrolyzed by mixing the solution comprising titanium with a mixture of the source of silicon and water, a mixture of the source of aluminum and water or with a mixture of the source of aluminum, the source of silicon and water.

The solution comprising titanium and silicon can be hydrolyzed with a mixture of the source of aluminum and water. The solution comprising titanium and aluminum can be hydrolyzed with a mixture of the source of silicon and water. The solution comprising titanium, silicon, and aluminum can be hydrolyzed with water.

The titanate can be titanium alkoxide having the chemical structure:

Ti(OR₁)(OR₂)(OR₃)(OR₄)

wherein R₁ to R₄ are the same or different alkyl groups of 1 to about 30 carbon atoms, more particularly, the titanium can be selected from the group consisting of titanium (IV) isopropoxide, titanium (IV) n-butoxide, titanium (IV) methoxide, titanium (IV) ethoxide, and titanium (IV) n-propoxide and mixture thereof, even more particularly, the titanate can be titanium (IV) isopropoxide.

The water miscible solvent can be selected from the group consisting of an alcohol, aldehyde, ketone, nitrile and mixture thereof, in particular, the alcohol can be selected from the group consisting of methanol, ethanol, isopropanol or n-propanol, n-butanol, isobutanol, sec-butanol, tert-butanol, n-pentanol and mixture thereof.

The source of silicon can be selected from the group consisting of tetraethylorthosilicate, sodium silicate and potassium silicate and mixtures thereof, in particular, the source of silicon can be an alkoxysilane of the formula HSi(OR)₃, wherein R is an alkyl group containing 1 to about 6 carbon atoms or alkoxyorthosilicate of the formula Si(OR)₄, wherein R is an alkyl group containing 1 to about 6 carbon atoms.

The source of aluminum can be selected from the group consisting of aluminum trichloride hexahydrate, aluminum tribromide hexahydrate, aluminum nitrate nonahydrate, aluminum formate, aluminum ethoxide, aluminum propoxide, aluminum butoxide, aluminum acetate and mixtures thereof.

The disclosure additionally relates to titanium dioxide in an anatase crystalline form which is stable at temperatures above 900° C. made by the above-described process.

### BRIEF DESCRIPTION OF THE FIGURES

FIG. 1 is an X-ray powder diffraction pattern of the 1200° C. calcined material of Example 1.

### DETAILED DESCRIPTION

The present disclosure relates to a process for forming anatase titanium dioxide which is stable at temperatures over 900° C., particularly 1000° C.

An organic water-miscible solvent and a titanate are mixed to form a solution comprising titanium.

The titanate is more particularly a titanium alkoxide having the chemical structure:

Ti(OR₁)(OR₂)(OR₃)(OR₄)

wherein R₁ to R₄ are the same or different alkyl groups of 1 to about 30 carbon atoms. Typically, the titanium alkoxide is selected from the group consisting of titanium (IV) isopropoxide, titanium (IV) n-butoxide, titanium (IV) methoxide, titanium (IV) ethoxide, and titanium (IV) n-propoxide and mixtures thereof.

The organic water-miscible solvent is a carbon-containing solvent that is capable of being mixed with water, even in a high organic solvent-to-water ratio, e.g. as high as 99.9:0.1, without separation of the solvent from the water. Nonlimiting examples of the organic water-miscible solvent can be selected from the group consisting of an alcohol, aldehyde, ketone, nitrile and mixtures thereof, in particular, the alcohol can be selected from the group consisting of methanol, ethanol, isopropanol or n-propanol, n-butanol, isobutanol, sec-butanol, tert-butanol, n-pentanol and mixtures thereof.

The solution comprising titanium is typically prepared at standard temperature and pressure conditions, typically the temperature for making up the solution ranges from about 10° C. to about 30° C.

The solution comprising titanium is hydrolyzed in the presence of a source of silicon and a source of aluminum to form a hydrolyzed composition of titanium doped with silicon and aluminum. Hydrolysis can be accomplished by adding water to the solution.

The source of silicon and the source of aluminum can be present for the hydrolysis by mixing them separately then adding them to the water, or adding them sequentially to the water then mixing them together with the water for hydrolysis, or adding a mixture of them to or adding them sequentially to the solution of the water miscible organic solvent and the titanate. As such, so long as the hydrolysis occurs in the presence of both dopants, the source of silicon and the source of aluminum can separately or together be introduced to the process by way of the water for hydrolysis, or by way of the solution of the organic water miscible solvent and the titanate or both.

In one embodiment of the disclosure, when the source of silicon or source of aluminum or both are soluble in organic solvents they can be mixed into the solution of the organic water miscible solvent and the titanate. In another embodiment of the disclosure when the source of silicon or source of aluminum or both are soluble in water, they can be mixed with the water for hydrolysis. It is also contemplated that one of the source of silicon or source of aluminum is soluble in organic solvent and the other is soluble in water and, as such, the organic soluble dopant is mixed with the organic water miscible solvent and the titanate and the water soluble dopant are mixed with the water for hydrolysis.

To enhance solubility for addition to the titanate solution, the mixture of water and dopant can be mixed with an organic water miscible solvent, which can be the same or different from the water miscible solvent that is mixed with the titanate. In particular, the organic water-miscible solvent for mixing with the mixture of water and dopant can be selected from the group consisting of an alcohol, aldehyde, ketone, nitrile and mixture thereof, in particular, the alcohol can be selected from the group consisting of methanol, ethanol, isopropanol or n-propanol, n-butanol, isobutanol, sec-butanol, tert-butanol, n-pentanol and mixture thereof.

Examples of suitable sources of the silicon dopant are selected from the group consisting of, but not limited to, tetraethylorthosilicate, sodium silicate, and potassium silicate.

Examples of suitable sources of the aluminum dopant are selected from the group consisting of, but not limited to, aluminum trichloride hexahydrate, aluminum tribromide hexahydrate, aluminum nitrate nonahydrate, and aluminum acetate.

The ratio of titanate to dopant can be in the range of about 0.65:about 0.35 to about 0.95:about 0.05, more typically in the range of about 0.7:about 0.3 to about 0.9:about 0.1, even more typically in the range of about 0.75:about 0.25 to about 0.85:about 0.15. The ratio of the source of silicon to the source of aluminum can be in the range of about 0.02:about 0.18 to about 0.18:about 0.02. more typically in the range of about 0.05:about 0.15 to about 0.15:about 0.05, even more typically in the range of about 0.075:about 0.125 to about 0.125:to about 0.075.

Sufficient water for hydrolysis is mixed with the titanate solution to form a hydrolyzed composition of titanium doped with silicon and aluminum by precipitation. Hydrolysis can occur at temperatures ranging from about 0° C. to about 40° C. Exposing the slurry to elevated temperatures is not necessary.

Hydrolyzing the titanium in the presence of a source of silicon and a source of aluminum forms a mixture of precipitated titanium, aluminum and silicon hydrous oxides and byproducts. The byproducts vary depending upon the starting materials. The byproducts can comprise alcohols, halides, nitrates, and alkali metals. The byproducts can be in the liquid phase of the mixture, or adsorbed onto the hydrous oxide, or trapped within the precipitate. As an example, when the starting material is a chloride, a portion of the chloride can form part of the precipitated hydrous oxide and another portion of the chloride can be in the liquid phase which comprises the water and water miscible organic solvent.

The hydrolyzed composition can be calcined to form high temperature stable anatase titanium dioxide doped with silicon and aluminum, in particular the calcining temperatures can range from about 400° C. to about 1200° C., more typically from about 400° C. to about 1000 ° C., even more typically from about 450° C. to about 800° C. Upon reaching the calcining temperature, the product can be exposed to the calcining temperature for a period of time ranging from about 5 minutes to about 12 hours, more typically about 30 minutes to about 8 hours, even more typically about 1 hour to about 4 hours. Prior to calcining the dried product can be ground into a powder by any suitable grinding technique.

Prior to calcining, the hydrolyzed composition which is usually in the form of a slurry can be separated from the slurry by any suitable means such as filtration to form a filter cake followed, optionally, by drying the filter cake. Optionally, the hydrolyzed composition can be washed to lower or remove the byproduct content. Washing is typically employed when starting materials contain inorganic cations and anions.

Compositions of matter of this disclosure can be used as a catalyst or catalyst support. For example, the catalytic properties of TiO₂ are well known to those skilled in the catalyst art. Use of the compositions of matter of this invention as catalysts or catalyst supports would be apparent to those skilled in the catalyst art. The anatase titanium dioxide product of this disclosure can be effective for catalytic applications where the temperatures can exceed 1000° C., typically 1100° and up to 1200° C. since it has been found that the combination of silicon and aluminum atoms as dopants in the crystal structure of the titanium dioxide increase the temperature at which the titanium dioxide transitions from the anatase form to the rutile form. At temperatures of about 1100° , it has been found that the titanium dioxide is predominantly in the anatase form, typically 100% anatase and free of rutile and amorphous forms. The presence of rutile can be temperature and time dependent. At temperatures of about 1200° C., the titanium dioxide product can contain rutile crystals. It was found that after heating the anatase titanium dioxide product of this disclosure at 1200° C. for four hours the X-ray powder diffraction pattern showed an amount of rutile which was estimated to be about 45% of the entire composition. Thus, the titanium dioxide product can be useful at temperatures around 1200° and higher where a proportion of rutile crystals will not impact the performance.

In one embodiment, the disclosure herein can be construed as excluding any element or process step that does not materially affect the basic and novel characteristics of the composition or process. Additionally, the disclosure can be construed as excluding any element or process step not specified herein.

Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The examples which follow, description of illustrative and preferred embodiments of the present invention are not intended to limit the scope of the invention. Various modifications, alternative constructions and equivalents may be employed without departing from the true spirit and scope of the appended claims.

### Test Methods

The following test methods and procedures were used in the Examples below:

X-Ray Powder Diffraction: Room-temperature powder x-ray diffraction data were obtained with a Philips X'PERT automated powder diffractometer, Model 3040. Samples were run in batch mode with a Model PW 1775 or Model PW 3065 multi-position sample changer. The diffractometer was equipped with an automatic variable slit, a xenon proportional counter, and a graphite monochromator. The radiation was CuK(alpha) (45 kV, 40 mA). Data were collected from 2 to 60 degrees 2-theta; a continuous scan with an equivalent step size of 0.03 deg; and a count time of 0.5 seconds per step. From the x-ray diffraction patterns, the average crystal domain size (nm) was estimated from the width of the diffraction peak at 2⊖˜25.3.

### EXAMPLES In these examples, are parts, percentages, and proportions are by weight, unless stated otherwise.

### Comparative Example 1

This example illustrates that the TiO₂ anatase to rutile structural transformation occurs at about 650° C. on calcining the product obtained by mixing tetraisopropyl titanate with water in isopropanol with no added silicon or aluminum.

16 mL tetraisopropyl titanate (DuPont Tyzor TPT, 97%) were mixed with about 200 mL isopropanol to make a solution. This solution was mixed with another solution comprising 300 mL isopropanol and 4 mL deionized H₂O, followed by the addition of 10 mL deionized water to produce a white slurry. An additional 230 mL deionized H₂O were added and the slurry was heated to boiling, and boiled for about 5 minutes. After cooling to room temperature, the slurry was filtered and the filter cake was dried overnight under an IR heat lamp. The dried product was ground to a powder in a mortar, transferred to an alumina tray and heated uncovered, in air, in a box furnace, from room temperature to about 450° C. over the period of one hour, and held at about 450° C. for an additional hour. The furnace was allowed to cool naturally to room temperature, and the fired material was recovered. An X-ray powder diffraction pattern of the calcined material showed only the broad lines of anatase and from the width of the strong peak at 2⊖˜25.3° an average crystal domain size of 11 nm was estimated.

A portion of this 450° C. calcined material was heated in an alumina crucible over a period of two hours to about 650° C. and held at this temperature for four hours. An X ray powder diffraction pattern of the 650° C. calcined material showed a mixture of about 80% anatase and 20% rutile. For the anatase component, an average crystal domain size of 31 nm was estimated.

Another portion of the 450° C. calcined material was heated in an alumina crucible over a period of two hours to about 800° C. and held at this temperature for four hours. An X ray powder diffraction pattern of the 800° C. calcined material showed a mixture of anatase and rutile estimated to be about 10% anatase and 90% rutile. For the anatase component, an average crystal domain size of 29 nm was estimated.

Another portion of the 450° C. calcined material was heated in an alumina crucible over a period of three hours to about 900° C. and held at this temperature for four hours. An X ray powder diffraction pattern of the 900° C. calcined material showed only the lines of rutile.

The results are reported in Table 1.

### Comparative Example 2

This example illustrates that the TiO₂ anatase to rutile structural transformation occurs at about 900° C. on calcining the product obtained by mixing tetraisopropyl titanate with water in isopropanol in the presence of a source of silicon, and in the absence of a source of aluminum. 16 mL tetraisopropyl titanate (DuPont Tyzor TPT, 97%) and 1.5 mL tetraethylorthosilicate (TEOS) were mixed with about 200 mL isopropanol to make a solution. This solution was mixed with another solution comprising 300 mL isopropanol and 4 mL deionized H₂O, followed by the addition of 10 mL deionized water to produce a translucent white slurry. An additional 230 mL deionized H₂O were added and the slurry was heated to boiling, and boiled for about 5 minutes.

After cooling to room temperature, the slurry was filtered and the filter cake was dried overnight under an IR heat lamp. The dried product was ground to a powder in a mortar, transferred to an alumina tray and heated uncovered, in air, in a box furnace, from room temperature to about 450° C. over the period of one hour, and held at about 450° C. for an additional hour. The furnace was allowed to cool naturally to room temperature, and the fired material was recovered. An X ray powder diffraction pattern of the calcined material showed only the broad lines of anatase, and from the width of the strong peak at 2⊖˜25.3° an average crystal domain size of 6 nm was estimated.

A portion of this 450° C. calcined material was heated in an alumina crucible over a period of two hours to about 650° C. and held at this temperature for four hours. An X ray powder diffraction pattern of the 650° C. calcined material showed only the presence of anatase. An average crystal domain size of 9 nm was estimated.

Another portion of the 450° C. calcined material was heated in an alumina crucible over a period of two hours to about 800° C. and held at this temperature for four hours. An X ray powder diffraction pattern of the 800° C. calcined material showed only the presence of anatase. An average crystal domain size of 13 nm was estimated. Another portion of the 450° C. calcined material was heated in an alumina crucible over a period of three hours to about 900° C. and held at this temperature for four hours. An X ray powder diffraction pattern of the 900° C. calcined material showed a mixture of anatase and rutile estimated to be about 80% anatase and 20% rutile. For the anatase component, an average crystal domain size of 22 nm was estimated.

Another portion of the 450° C. calcined material was heated in an alumina crucible over a period of three hours to about 1000° C. and held at this temperature for four hours. An X ray powder diffraction pattern of the 1000° C. calcined material showed a mixture of anatase and rutile estimated to be about 30% anatase and 70% rutile. For the anatase component, an average crystal domain size of 26 nm was estimated.

Another portion of the 450° C. calcined material was heated in an alumina crucible over a period of three hours to about 1100° C. and held at this temperature for four hours. An X ray powder diffraction pattern of the 1100° C. calcined material showed a mixture of anatase and rutile estimated to be about 8% anatase and 92% rutile. For the anatase component, an average crystal domain size of 41 nm was estimated.

Another portion of the 450° C. calcined material was heated in an alumina crucible over a period of three hours to about 1200° C. and held at this temperature for four hours. An X ray powder diffraction pattern of the 1200° C. calcined material showed only the presence of rutile.

The results are summarized in Table 1.

### Comparative Example 3

This example illustrates that the TiO₂ anatase to rutile structural transformation occurs at about 900° C. on calcining the product obtained by mixing tetraisopropyl titanate with water in isopropanol in the presence of a source of aluminum, and in the absence of a source of silicon. 16 mL tetraisopropyl titanate (DuPont Tyzor TPT, 97%) were mixed with about 200 mL isopropanol to make a solution. Another solution was prepared by dissolving 1.62 g AlCl₃.6H₂O in 4 mL deionized H₂O and mixing this aqueous solution with 300 mL isopropanol. The titanium and aluminum containing alcoholic solutions were mixed, and 10 mL deionized water were added to produce a translucent white slurry. An additional 250 mL deionized H₂O were added and the slurry was heated to boiling, and boiled for about 5 minutes.

After cooling to room temperature, the slurry was filtered and the filter cake was dried overnight under an IR heat lamp. The dried product was ground to a powder in a mortar, transferred to an alumina tray and heated uncovered, in air, in a box furnace, from room temperature to about 450° C. over the period of one hour, and held at about 450° C. for an additional hour. The furnace was allowed to cool naturally to room temperature, and the fired material was recovered. An X ray powder diffraction pattern of the calcined material showed only the broad lines of anatase, and from the width of the strong peak at 2⊖˜25.3° an average crystal domain size of 8 nm was estimated.

A portion of this 450° C. calcined material was heated in an alumina crucible over a period of two hours to about 650° C. and held at this temperature for four hours. An X ray powder diffraction pattern of the 650° C. calcined material showed only the presence of anatase. An average crystal domain size of 11 nm was estimated.

Another portion of the 450° C. calcined material was heated in an alumina crucible over a period of two hours to about 800° C. and held at this temperature for four hours. An X ray powder diffraction pattern of the 800° C. calcined material showed only the presence of anatase. An average crystal domain size of 23 nm was estimated.

Another portion of the 450° C. calcined material was heated in an alumina crucible over a period of three hours to about 900° C. and held at this temperature for four hours. An X ray powder diffraction pattern of the 900° C. calcined material showed a mixture of anatase and rutile estimated to be about 65% anatase and 35% rutile. For the anatase component, an average crystal domain size of 37 nm was estimated.

Another portion of the 450° C. calcined material was heated in an alumina crucible over a period of three hours to about 1000° C. and held at this temperature for four hours. An X ray powder diffraction pattern of the 1000° C. calcined material showed a mixture of anatase and rutile estimated to be about 2% anatase and 98% rutile. The very low intensity of the anatase diffraction peaks made it difficult to estimate the average crystal domain size.

Another portion of the 450° C. calcined material was heated in an alumina crucible over a period of three hours to about 1100° C. and held at this temperature for four hours. An X ray powder diffraction pattern of the 1100° C. calcined material showed only the presence of rutile.

The results are summarized in Table 1.

### Example 1

This example illustrates that some TiO₂ undergoes the anatase to rutile structural transformation at about 1100-1200° C. on calcining the product obtained by mixing tetraisopropyl titanate with water in isopropanol in the presence of sources of aluminum and silicon.

16 mL tetraisopropyl titanate (DuPont Tyzor TPT, 97%) and 1.5 mL tetraethylorthosilicate (TEOS) were mixed with about 200 mL isopropanol to make a solution. Another solution was prepared by dissolving 1.62 g AlCl₃.6H₂O in 4 mL deionized H₂O and mixing this aqueous solution with 300 mL isopropanol. The two alcoholic solutions were mixed, and 10 mL deionized water were added to produce a translucent white slurry. An additional 240 mL deionized H₂O were added and the slurry was heated to boiling, and boiled for about 5 minutes.

After cooling to room temperature, the slurry was filtered and the filter cake was dried overnight under an IR heat lamp. The dried product was ground to a powder in a mortar, transferred to an alumina tray and heated uncovered, in air, in a box furnace, from room temperature to about 450° C. over the period of one hour, and held at about 450° C. for an additional hour. The furnace was allowed to cool naturally to room temperature, and the fired material was recovered. An X ray powder diffraction pattern of the calcined material showed only the broad lines of anatase, and from the width of the strong peak at 2⊖˜25.3° an average crystal domain size of 6 nm was estimated.

A portion of this 450° C. calcined material was heated in an alumina crucible over a period of two hours to about 650° C. and held at this temperature for four hours. An X ray powder diffraction pattern of the 650° C. calcined material showed only the presence of anatase. An average crystal domain size of 7 nm was estimated.

Another portion of the 450° C. calcined material was heated in an alumina crucible over a period of two hours to about 800° C. and held at this temperature for four hours. An X ray powder diffraction pattern of the 800° C. calcined material showed only the presence of anatase. An average crystal domain size of 9 nm was estimated.

Another portion of the 450° C. calcined material was heated in an alumina crucible over a period of two hours to about 900° C. and held at this temperature for four hours. An X ray powder diffraction pattern of the 900° C. calcined material showed only the presence of anatase. An average crystal domain size of 12 nm was estimated.

Another portion of the 450° C. calcined material was heated in an alumina crucible over a period of two hours to about 1000° C. and held at this temperature for four hours. An X ray powder diffraction pattern of the 1000° C. calcined material showed only the presence of anatase. An average crystal domain size of 19 nm was estimated.

Another portion of the 450° C. calcined material was heated in an alumina crucible over a period of three hours to about 1100° C. and held at this temperature for four hours. An X ray powder diffraction pattern of the 1100° C. calcined material showed anatase as the major product and rutile as a minor product, the mixture estimated to consist of about 97% anatase and 3% rutile. For the anatase component, an average crystal domain size of 35 nm was estimated.

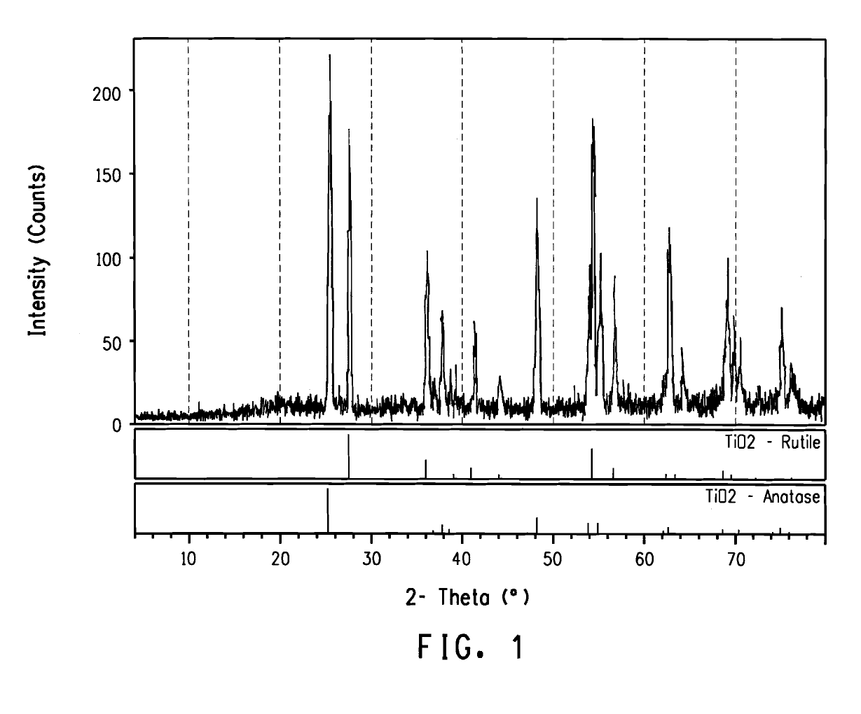

Another portion of the 450° C. calcined material was heated in an alumina crucible over a period of three hours to about 1200° C. and held at this temperature for four hours. FIG. 1 is an X ray powder diffraction pattern of the 1200° C. calcined material showed a mixture of anatase and rutile estimated to be about 55% anatase and 45% rutile. For the anatase component, an average crystal domain size of 29 nm was estimated.

The results are summarized in Table 1.

TABLE 1*

| Temperature | Comparative | Comparative | Comparative | |
|---|---|---|---|---|
| (° C.) | Example 1 | Example 2 | Example 3 | Example 1 |
| 450 | 100 A | 100 A | 100 A | 100 A |
| 650 | 80 A; 20 R | 100 A | 100 A | 100 A |
| 800 | 10 A; 90 R | 100 A | 100 A | 100 A |
| 900 | 100 R | 80 A; 20 R | 65 A; 35 R | 100 A |
| 1000 | | 30 A; 70 R | 2 A; 98 R | 100 A |
| 1100 | | 8 A; 92 R | 100 R | 97 A; 3 R |
| 1200 | | 100 R | | 55 A; 45 R |

| | Relative Average Anatase Crystal Domain Size (nm) | | | |
|---|---|---|---|---|
| | | | | Example 1 |
| Temp | Comp. Ex 1 | Comp. Ex 2 | Comp Ex 3 | Si and Al |
| (° C.) | no dopants | Si doped | Al doped | doped |
| 450 | 11 | 6 | 8 | 6 |
| 650 | 31 | 9 | 11 | 7 |
| 800 | 29 | 13 | 23 | 9 |
| 900 | | 22 | 37 | 12 |
| 1000 | | 26 | | 19 |
| 1100 | | 41 | | 35 |
| 1200 | | | | 29 |

*A = % Anatase; R = % Rutile

What is claimed is:

1. A process for making anatase titanium dioxide which is stable at temperatures above 900° C., comprising:
(a) mixing an organic water-miscible solvent and a titanate to form a solution comprising titanium;
(b) hydrolyzing the solution comprising titanium in the presence of a source of silicon and a source of aluminum to form a hydrolyzed composition of titanium doped with silicon and aluminum;
(c) separating the hydrolyzed composition of titanium doped with silicon and aluminum; and
(d) calcining the hydrolyzed composition of titanium doped with silicon and aluminum to form high temperature stable anatase titanium dioxide doped with silicon and aluminum.

2. The process of claim 1 further comprising adding the source of silicon to the solution comprising titanium.

3. The process of claim 1 further comprising adding the source of aluminum to the solution comprising titanium.

4. The process of claim 1 further comprising adding the source of silicon and the source of aluminum to the solution comprising titanium to form a solution comprising titanium, silicon and aluminum.

5. The process of claim 3 in which the solution comprising titanium and aluminum is hydrolyzed by mixing the solution comprising titanium and aluminum with a mixture of the source of silicon and water.

6. The process of claim 2 in which the solution comprising titanium and silicon is hydrolyzed by mixing the solution comprising titanium and silicon with a mixture of the source of aluminum and water.

7. The process of claim 1 in which the solution comprising titanium is hydrolyzed by mixing the solution comprising titanium with a mixture of the source of aluminum, the source of silicon and water.

8. The process of claim 4 further comprising mixing the solution comprising titanium, silicon, and aluminum with water to form the hydrolyzed composition of titanium doped with silicon and aluminum.

9. The process of claim 1 in which the titanate is titanium alkoxide having the chemical structure:
Ti(OR₁)(OR₂)(OR₃)(OR₄)
wherein R₁ to R₄ are the same or different alkyl groups of 1 to about 30 carbon atoms.

10. The process of claim 1 in which the titanate is selected from the group consisting of titanium (IV) isopropoxide, titanium (IV) n-butoxide, titanium (IV) methoxide, titanium (IV) ethoxide, and titanium (IV) n-propoxide and mixture thereof.

11. The process of claim 1 in which the titanate is titanium (IV) isopropoxide.

12. The process of claim 1 in which the organic water miscible solvent is selected from the group consisting of an alcohol, aldehyde, ketone, nitrile and mixture thereof.

13. The process of claim 11 in which the alcohol is selected from the group consisting of methanol, ethanol, isopropanol or n-propanol, n-butanol, isobutanol, sec-butanol, tert-butanol, n-pentanol and mixture thereof.

14. The process of claim 1 in which the source of silicon is selected from the group consisting of sodium silicate and potassium silicate and mixtures thereof.

15. The process of claim 1 in which the source of silicon is an alkoxysilane of the formula HSi(OR)₃, wherein R is an alkyl group containing 1 to 6 carbon atoms or alkoxyorthosilicate of the formula Si(OR)₄, wherein R is an alkyl group containing 1 to 6 carbon atoms.

16. The process of claim 1 in which the source of aluminum is selected from the group consisting of aluminum trichloride hexahydrate, aluminum tribromide hexahydrate, aluminum nitrate nonahydrate, aluminum formate, aluminum ethoxide, aluminum propoxide, aluminum butoxide, aluminum acetate and mixtures thereof.

17. The process of claim 1 in which the hydrolyzed composition of titanium doped with silicon and aluminum is calcined at a temperature of from about 400° C. to about 1200° C.

18. The process of claim 1 in which the titanium dioxide in an anatase crystalline form is stable at temperatures ranging from above 900° C. to about 1200° C.

19. Titanium dioxide in an anatase crystalline form which is stable at temperatures above 900° C. made by a process, comprising:
(a) mixing an organic water-miscible solvent and a titanate to form a solution comprising titanium;
(b) hydrolyzing the solution comprising titanium in the presence of a source of silicon and a source of aluminum to form a hydrolyzed composition of titanium doped with silicon and aluminum;
(c) separating the hydrolyzed composition of titanium doped with silicon and aluminum; and
(d) calcining the hydrolyzed composition of titanium doped with silicon and aluminum to form high temperature stable anatase titanium dioxide doped with silicon and aluminum.

20. The titanium dioxide of claim 19 in which the titanate is titanium alkoxide having the chemical structure:
Ti(OR₁)(OR₂)(OR₃)(OR₄)
wherein R₁ to R₄ are the same or different alkyl groups of 1 to about 30 carbon atoms.

21. The titanium dioxide of claim 19 in which the titanate is titanium (IV) isopropoxide.

22. The titanium dioxide of claim 19 in which the water miscible solvent is an alcohol selected from the group consisting of methanol, ethanol, isopropanol or n-propanol, n-butanol, isobutanol, sec-butanol, tert-butanol, n-pentanol and mixture thereof.

23. The titanium dioxide of claim 19 in which the source of silicon is selected from the group consisting of sodium silicate and potassium silicate, alkoxysilane of the formula HSi(OR)₃, wherein R is an alkyl group containing 1 to 6 carbon atoms or alkoxyorthosilicate of the formula Si(OR)₄, wherein R is an alkyl group containing 1 to 6 carbon atoms and mixtures thereof.

24. The titanium dioxide of claim 19 in which the source of aluminum is selected from the group consisting of aluminum trichloride hexahydrate, aluminum tribromide hexahydrate, aluminum nitrate nonahydrate, aluminum formate, aluminum ethoxide, aluminum propoxide, aluminum butoxide, aluminum acetate and mixtures thereof.

25. The titanium dioxide of claim 19 in which the hydrolyzed composition of titanium doped with silicon and aluminum is calcined at a temperature of from about 400° C. to about 1200° C.
